(19) United States
(12) Patent Application Publication
(10) Pub. No.: US 2005/0182772 A1
(43) Pub. Date: Aug. 18, 2005

(54) Method of streaming conversion from a first data structure to a second data structure

(76) Inventors: Rohit Mital, Colorado Springs, CO (US); Kirstan Anderson Vandersluis, Colorado Springs, CO (US)

Correspondence Address: LAW OFFICE OF DALE B. HALLING, 24 s. WEBER ST., SUITE 311, COLORADO SPRINGS, CO, 80903, US

(21) Appl. No.: 10/778,375

(22) Filed: Feb. 13, 2004

(51) Int. Cl. G06F 7/00

(52) U.S. Cl. 707/100

(57) ABSTRACT

A method of streaming conversion from a first data structure to a second data structure includes the steps of receiving a reference to an input data stream in the first data structure for conversion. A document conversion file is received that converts data in the first data structure to data in the second data structure. Next, a repeating structure definition is received. The document conversion file is executed. Then each instance of a repeating structure is streamed.

### FIELD OF THE INVENTION

The present invention relates generally to the field of data networks and more particularly to a method of streaming conversion from a first data structure to a second data structure.

### BACKGROUND OF THE INVENTION

The present invention relates to computer systems interconnected by a network, suitably configured to transfer data between one another. A computer system connected to the network processes data from a plurality of data sources. A data source can be an input device attached to the computer system, or can be a storage device, memory, database, or other computer system attached either locally or remotely to the computer system via a network. In the network of computers, at any given time, a computer system may assume a specific role, relative to the processing of data. A computer system that sends a request for data to another computer system is said to be a Client system. The computer system that processes requests from other computer systems is said to be a Server system. When a Client sends a request for data to a Server, the Server may retrieve some of the requested data from its local resources, and some of the data from an External source on the network. The Server in this case acts as a Client to an External source, requesting the appropriate data, and the External source acts as a Server. Thus, a computer system on the network may at one time perform the role of a Client, and at another time perform the role of a Server.

Unfortunately, each computer may store data in a different format or data structure. In order for a client and server to exchange information where the client and server use different data formats, it is necessary the input data be converted to the client's data format before it is sent to the client. Examples of such a system are described in U.S. Pat. No. 6,356,920 entitled “Dynamic Hierarchical Data Exchange” and U.S. application Ser. No. 09/900,079 entitled “System and Method for Converting Data in a First Hierarchical Data Scheme into a Second Hierarchical Data Scheme”, both assigned to the same assignee as the present application. When either the client or server uses a self descriptive data format such as XML (eXtensible Markup Language), very large files in memory can be created. If the computer has limited memory, this can degrade the systems performance.

Thus there exists a need for a data conversion system that is able to handle large files without degrading system performance.

### SUMMARY OF THE INVENTION

A method of streaming conversion from a first data structure to a second data structure includes the steps of receiving a reference to a input data stream in the first data structure for conversion. A document conversion file is received that converts data in the first data structure to data in the second data structure. Next, a repeating structure definition is received. The document conversion file is executed. Then each instance of a repeating structure is streamed. In one embodiment, each instance of the repeating structure is written to an output file. A present instance of the repeating structure is appended to a preceding instance of the repeating structure.

In one embodiment, an instance of the repeating structure is received from the file.

In one embodiment, the file in the first data structure is received before processing begins.

In another embodiment, the file is selected from the group of: extensible markup language schemes, relational databases, non-relational databases and self describing databases.

In one embodiment, a component conversion file referenced by the document conversion file is received. A driver conversion file referenced by the document conversion file is received.

In one embodiment, the repeating structure definition is a reference to a component conversion file.

In one embodiment, a method of streaming conversion from a first data structure to a second data structure includes the steps of receiving a file in the first data structure. A conversion of the file to the second data structure is started. When an instance of a repeating structure is converted to the second data structure, the instance of the repeating structure is written to an output file. In one embodiment, the conversion includes receiving a document conversion file and a definition of the repeating structure. A document component file and a driver conversion file may also be received.

In one embodiment the process is repeated until all the instances of the repeating structures have been converted.

In one embodiment, a document component file defines the repeating structure.

In one embodiment, a method of streaming conversion from a first data structure to a second data structure includes the steps of receiving a reference to a file in a first data structure. A first instance of a repeating structure is received from the file. The first instance of the repeating structure is converted to the second data structure. A next instance of the repeating structure is received from the file. The next instance of the repeating structure is converted to the second data structure. This process may be repeated until all the instances of the repeating structure have been converted.

In one embodiment, a document conversion file is received. A component conversion file referenced in the document conversion file may also be received. A repeating definition that defines the component conversion file as the repeating structure may also be received.

### BRIEF DESCRIPTION OF THE DRAWINGS

FIG. 1 is a schematic example of streaming conversion from a first data structure to a second data structure in accordance with one embodiment of the invention;

FIG. 2 is a schematic example of streaming conversion from a first data structure to a second data structure in accordance with one embodiment of the invention;

FIG. 3 is block diagram of data conversion system in accordance with one embodiment of the invention;

FIG. 4 is a flow chart of the steps used in streaming conversion from a first data structure to a second data structure in accordance with one embodiment of the invention;

FIG. 5 is a flow chart of the steps used in streaming conversion from a first data structure to a second data structure in accordance with one embodiment of the invention;

FIG. 6 is a flow chart of the steps used in streaming conversion from a first data structure to a second data structure in accordance with one embodiment of the invention;

FIG. 7 is an example of a document conversion file in accordance with one embodiment of the invention;

FIG. 8 is an example of a component conversion file in accordance with one embodiment of the invention;

FIGS. 9a & b are an example of an XML document in accordance with one embodiment of the invention;

FIG. 10 is an example of a document conversion file in accordance with one embodiment of the invention; and

FIG. 11 is an example of a document conversion file for streaming in XML input information in accordance with one embodiment of the invention; and

FIG. 12 is an example of a document conversion file for streaming out XML output information in accordance with one embodiment of the invention.

### DETAILED DESCRIPTION OF THE DRAWINGS

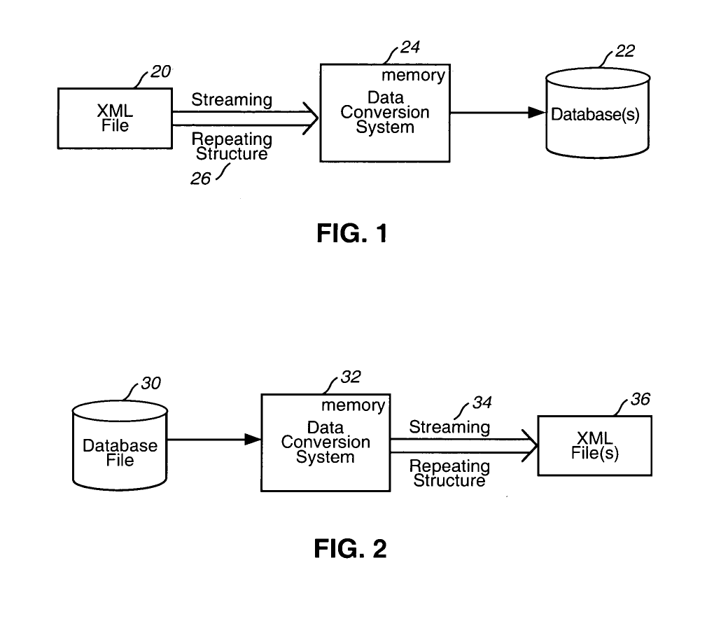

The present invention relates to streaming conversion of data between formats. FIG. 1 is a schematic example of streaming conversion from a first data structure to a second data structure in accordance with one embodiment of the invention. In this example, data in an XML file 20 is being converted into a database format 22. Note that while the example shows XML, the file 20 could be in any data format and the database 22 could represent any data format. In addition, the input may be an input data stream which may be a file, data from a web site, data from an instrument, output from a program or other data source. In this example, a data conversion system 24 is loaded into the memory of a computer. The XML file 20 is assumed to be very large although it is not necessary. Loading a large XML file 20 may limit the performance of the computer system running the data conversion system 24. As a result, a repeating portion of the XML file 20 is streamed to memory and the data conversion system. An example of a repeating structure might be an order in a file of all the orders for a week. Each instance of the repeating structure is written to memory. The instance of the repeating structure is converted to the second data structure and written to a database(s) 22 by the data conversion system 24. This process is repeated until all instances of the repeating structure are converted to the second data structure. An instance of the repeating data structure would be a specific order. While the example shows an XML to a database data structure either data structure could be selected from the group including: extensible markup language schemes, relational databases, non-relational databases and self describing databases.

FIG. 2 is a schematic example of streaming conversion from a first data structure to a second data structure in accordance with one embodiment of the invention. This figure is similar to FIG. 1 except the input file or information is a database file 30. As the data conversion system 32 executes its document conversion file or process data is pulled from the database(s) 30. When an instance of the repeating structure is converted to XML (second data structure), it is streamed (written) 34 to an XML file 36. Each new instance is appended to the earlier instance in the XML file 36 or files. Note that it is possible to combine FIGS. 1 & 2 have the input streamed and the output streamed. In addition, the output could be written to multiple output files.

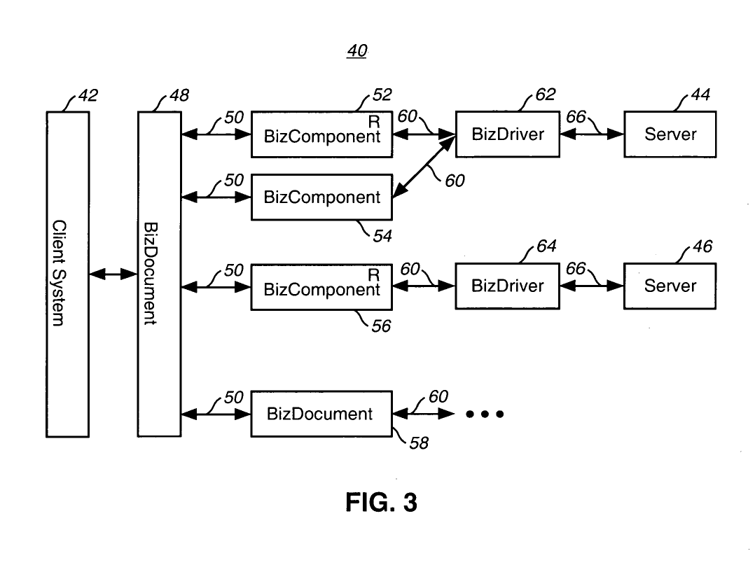

FIG. 3 is block diagram of data conversion system 40 in accordance with one embodiment of the invention. Note that the client 42 and servers 44 & 46 are not part of the underlying system 40 but provide the information the system 40 operates on. The client system 42 requests information from the system 40. The required information is located in the servers 44 & 46. The system 40 has to convert the data in the servers 44 & 46 into the format (data structure) required by the client 42. The system 40 includes a document conversion file (BizDocument) 48 that describes the overall data conversion process. The document conversion file 48 calls or references 50 one or more component conversion files (BizComponent) 52, 54, 56 & 58. A component conversion file 52, 54, 56, 58 may call or reference a second component conversion file 52, 54, 56, 58 or may call or reference 60 a driver conversion file (BizDriver) 62 & 64. The drive conversion file 62 & 64 interfaces 66 with a server 44 & 46. The component conversion files 52, 54, 56 & 58 are dedicated to converting certain portions of a data file and the driver conversion files 62 & 64 are standard drivers required for two machines to interface. The component conversion files 52 & 56 have a “R” which indicates that this is a repeating structure and should be streamed. If streaming of the data is required, at least one of the component conversion files must designated a repeating structure.

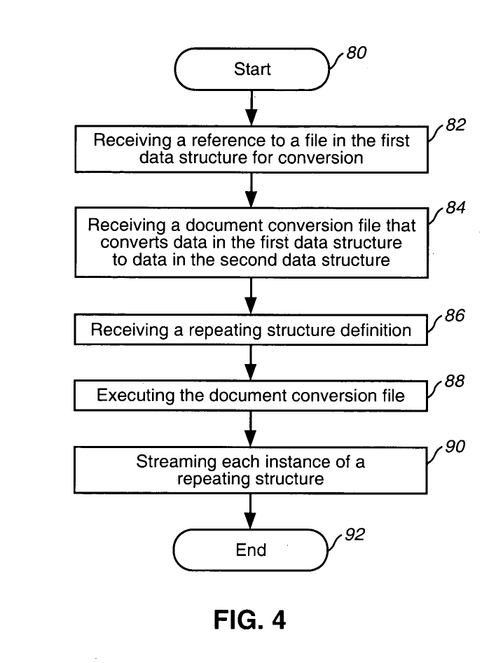

FIG. 4 is a flow chart of the steps used in streaming conversion from a first data structure to a second data structure in accordance with one embodiment of the invention. The process starts, step 80, by receiving a reference to a file in the first data structure for conversion at step 82. This may be accomplished by a user designating a file, such as the weeks purchase orders, for conversion. Next a document conversion file that converts data in the first data structure to data in the second data structure is received at step 84. This may be accomplished by loading a document conversion file in memory. A repeating structure definition is received at step 86. The repeating structure definition may defined in user interface. The document conversion filed is executed at step 88. At step 90, each instance of the repeating structure is streamed which ends the process at step 92. In one embodiment, the input is streamed by reading each instance of the repeating structure into memory. In another embodiment, the output is streamed by writing each instance of the repeating structure to a file.

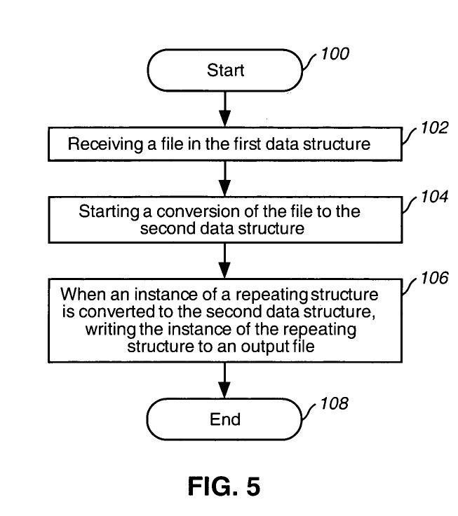

FIG. 5 is a flow chart of the steps used in streaming conversion from a first data structure to a second data structure in accordance with one embodiment of the invention. The process starts, step 100, by receiving a file in the first data structure at step 102. Next a conversion of the file to second data structure is started at step 104. When an instance of a repeating structure is converted to the second data structure at step 106, the instance of the repeating structure is written to an output file which ends the process at step 108. In one embodiment, steps 104 and 106 are repeated until every instance of the repeating structure has been converted to the second data structure. In another embodiment the output file is an output data stream.

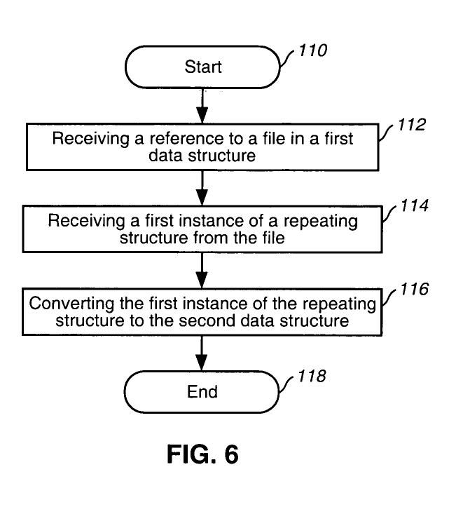

FIG. 6 is a flow chart of the steps used in streaming conversion from a first data structure to a second data structure in accordance with one embodiment of the invention. The process starts, step 110, by receiving a reference to a file in a first data structure at step 112. Next a first instance of the repeating structure from the file is received at step 114. At step 116 the first instance of the repeating structure is converted to the second data structure which ends the process at step 118. In one embodiment, steps 114 and 116 are repeated until all instances have been converted.

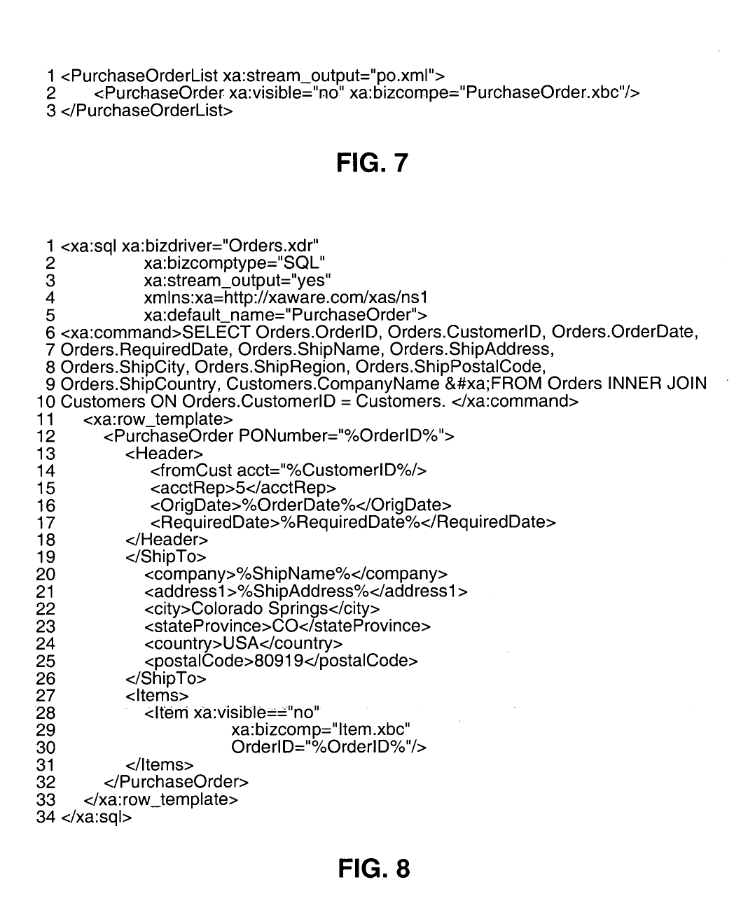

FIG. 7 is an example of a document conversion file in accordance with one embodiment of the invention. In this embodiment, the document conversion file is used to convert a relational database report or file into an XML file. The second line (2) calls a component conversion file titled “PurchaseOrder.xbc”. An example of this component conversion file is found in FIG. 8. Line three of the file PurchaseOrder.xbc alerts the processor that the output is going to be streamed. Thus the file PurchaseOrder.xbc is used to define the repeating structure. FIGS. 7 & 8 are the document conversion file and component conversion file required to stream the repeating structure of the purchase order into an XML file.

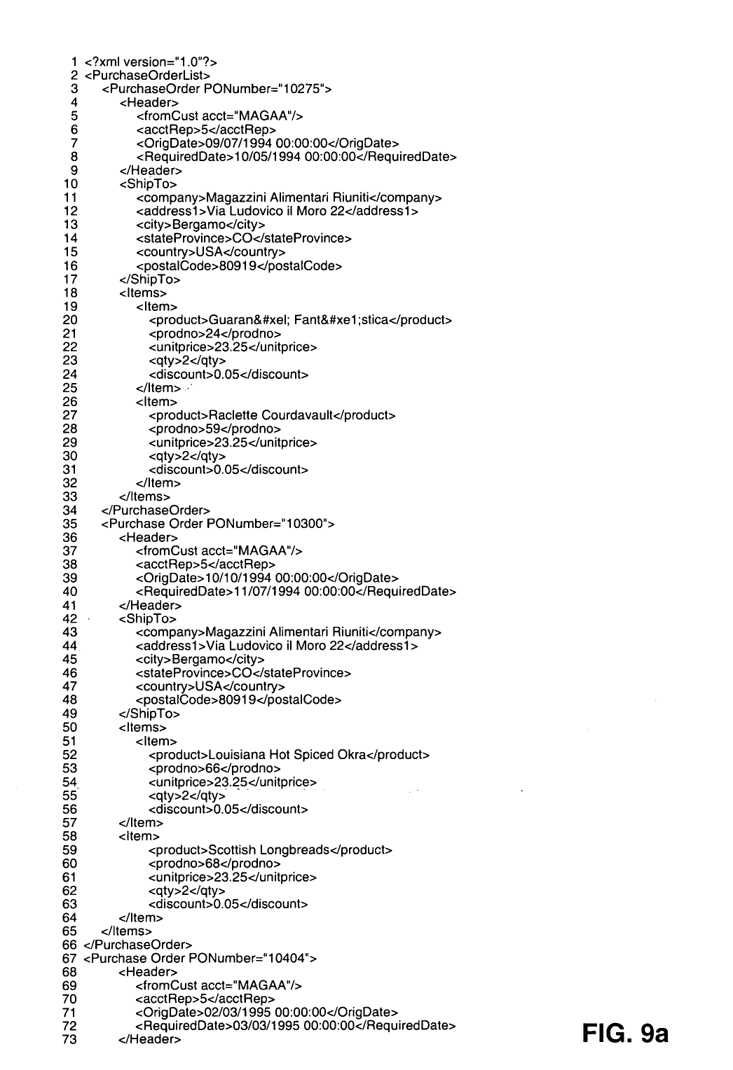

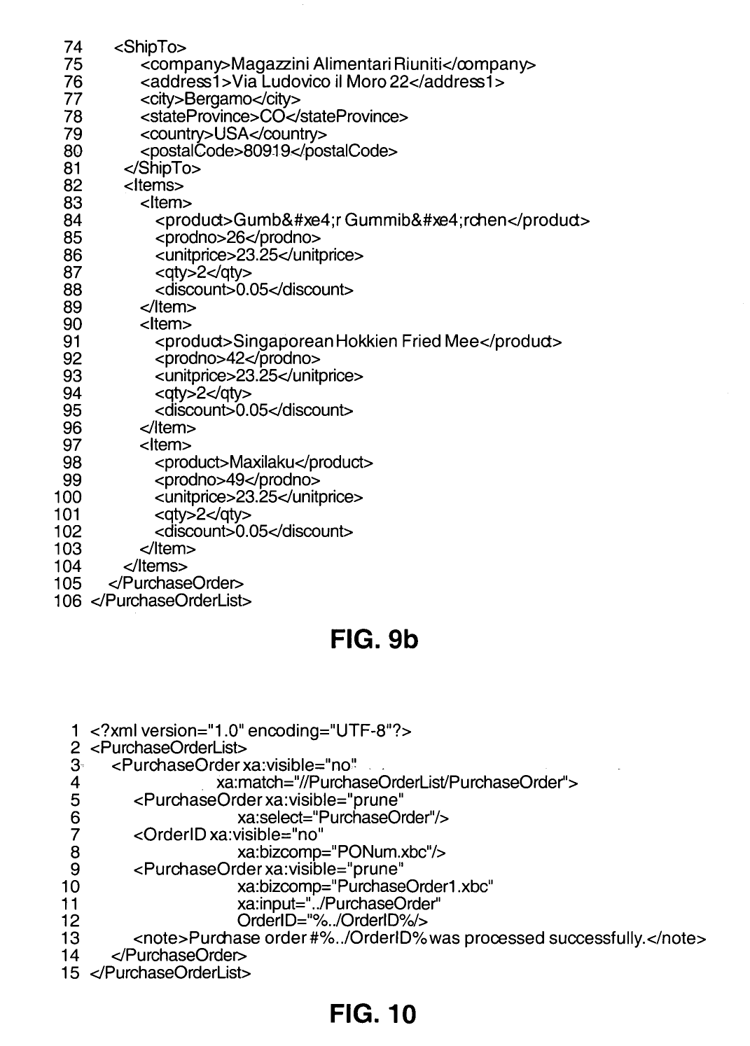

FIGS. 9a & b are an example of an XML document in accordance with one embodiment of the invention. Here you can see the repeating structure of the purchase orders starting on lines 2, 34 and 66. A real file might contain thousands of orders. FIG. 10 is an example of a document conversion file that can convert the XML file of FIGS. 9a & b into a relational database or other structure by streaming in the purchase orders. The document conversion file of FIG. 10 calls a component conversion file at line ten called “PurchaseOrder1.xbc” to read into memory each instance of a purchase order one at a time. As a result each instance of a purchase order is read or streamed into the data conversion system.

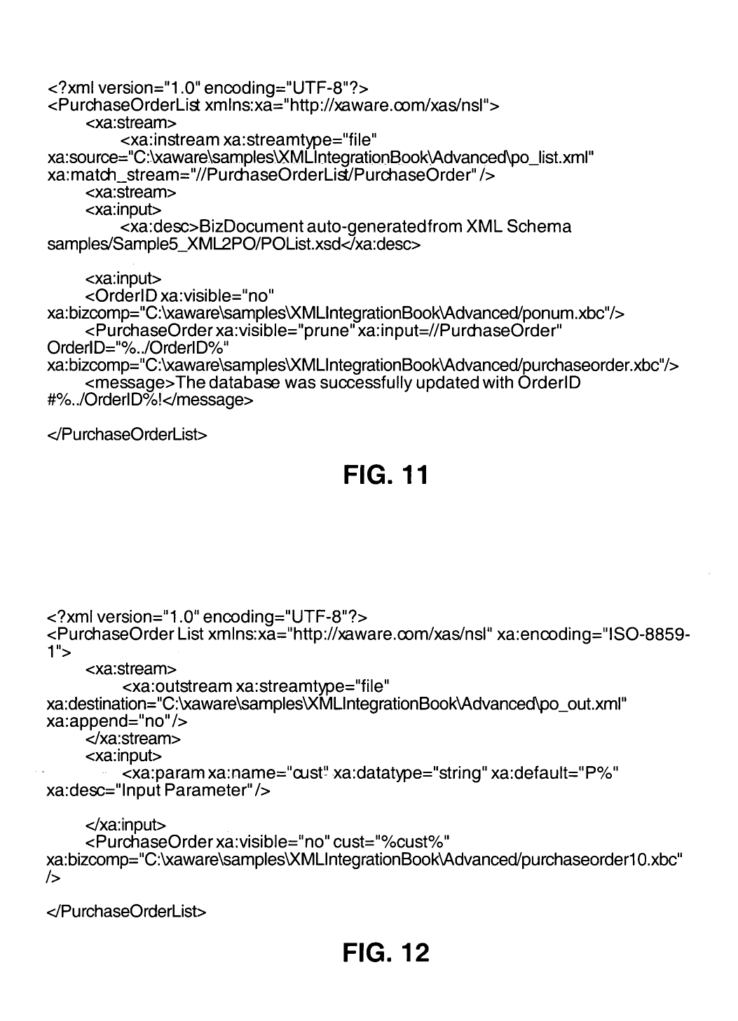

FIG. 11 is an example of a document conversion file for streaming in XML input information in accordance with one embodiment of the invention. The document conversion file of FIG. 11 is similar to the document conversion file of FIG. 10 except that it is for the JAVA operating system, while FIG. 10 is written for the Windows operating system.

FIG. 12 is an example of a document conversion file for streaming out XML output information in accordance with one embodiment of the invention. The document conversion file of FIG. 12 is similar to the document conversion file of FIG. 7 except that it is for the JAVA operating system, while FIG. 7 is written for the Windows operating system.

Thus there has been described a data conversion system, that is able to handle large files without degrading system performance.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A method of streaming conversion from a first data structure to a second data structure, comprising the steps of:
a) receiving a reference to an input data stream in the first data structure for conversion;
b) receiving a document conversion file that converts data in the first data structure to data in the second data structure;
c) receiving a repeating structure definition;
d) executing the document conversion file; and
e) streaming each instance of a repeating structure.

2. The method of claim 1, wherein step (e) further includes the step of:
e1) writing each instance of the repeating structure to an output file.

3. The method of claim 2, further including the step of:
f) appending a present instance of the repeating structure to a preceding instance of the repeating structure.

4. The method of claim 1, wherein step (e) further includes the step of:
e1) receiving an instance of the repeating structure from the input data stream.

5. The method of claim 1, wherein step (a) further includes the step of:
a1) receiving the input data stream in the first data structure.

6. The method of claim 1, wherein step (a) further includes the step of:
a1) receiving the input data stream selected from the group of: extensible markup language schemes, relational databases, non-relational databases and self describing databases.

7. The method of claims 1, wherein step (b) further includes the step of:
b1) receiving a component conversion file referenced by the document conversion file.

8. The method of claims 1, wherein step (b) further includes the step of:
b1) receiving a driver conversion file referenced by the document conversion file.

9. The method of claim 1, wherein step (c) further includes the step of:
c1) receiving a reference to a component conversion file.

10. A method of streaming conversion from a first data structure to a second data structure, comprising the steps of:
a) receiving an input data stream in the first data structure;
b) starting a conversion of the input data steam to the second data structure;
c) when an instance of a repeating structure is converted to the second data structure, writing the instance of the repeating structure to an output data stream.

11. The method of claim 10, wherein step (b) further includes the steps of:
b1) receiving a document conversion file;
b2) receiving a definition of the repeating structure.

12. The method of claim 1 1, further including the steps of:
b3) receiving a document component file.
b4) receiving a driver conversion file.

13. The method of claim 10, further including the step of:
d) repeating steps (b) and (c) until all the instances of the repeating structures have been converted.

14. The method of claim 10, wherein step (b) further includes the step of:
b1) receiving a document component file that defines the repeating structure.

15. A method of streaming conversion from a first data structure to a second data structure, comprising the steps of:
a) receiving a reference to a input data stream in a first data structure;
b) receiving a first instance of a repeating structure from the file; and
c) converting the first instance of the repeating structure to the second data structure.

16. The method of claim 15, further including the steps of:
d) receiving a next instance of the repeating structure from the input data stream;
e) converting the next instance of the repeating structure to the second data structure.

17. The method of claim 16, further including the step of:
f) repeating steps (d) and (e) until all the instances of the repeating structure have been converted.

18. The method of claim 15, wherein step (b) includes the step of:
b1) receiving a document conversion file.

19. The method of claim 18, further including the step of:
b2) receiving a component conversion file referenced in the document conversion file.

20. The method of claim 19, further including the step of:
b3) receiving a repeating definition that defines the component conversion file as the repeating structure.
